(19) United States
(12) Patent Application Publication
(10) Pub. No.: US 2005/0015548 A1
(43) Pub. Date: Jan. 20, 2005

(54) Method for transmitting data, particularly over an air interface

(75) Inventor: Dieter Horst, Cadolzburg (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/851,330

(22) Filed: May 24, 2004

(30) Foreign Application Priority Data
Sep. 23, 2002 (DE) 10244133.2

(51) Int. Cl. G06F 12/00

(52) U.S. Cl. 711/115; 711/170

(57) ABSTRACT

A method for transmitting data from a mobile data memory (DT) to a read/write device (SLG), in particular over an air interface (LS). The data are stored in a programmable electronic memory (MEM) having a fixed memory size (FIX). Only a predefined amount of user data (DATA) is transmitted, preferably cyclically, from the electronic memory. This has the advantage that only the required, user-programmable number (ANZ) of user data is transmitted. As a result, the crossing speed and/or the data volume transmitted between the mobile data memory and the read/write device are increased. The method is useful for mobile data memories and identification systems (IS) with at least one read/write device (SLG) and at least one mobile data memory.

This is a Continuation of International Application PCT/DE03/03002, published under PCT Article 21(2) in German, and the disclosure of which is incorporated into this application by reference.

### FIELD OF AND BACKGROUND OF THE INVENTION

The invention relates to a method for transmitting data of a mobile data memory to a read/write device, particularly over an air interface, such that the data can be stored in a programmable electronic memory with a fixed memory size. The invention further relates to a mobile data memory and a read/write device for carrying out the method, as well as to an identification system with a read/write device and at least one mobile data memory.

Contactless identification systems use contactless transmission methods, e.g., electromagnetic, infrared or ultrasonic means. Such systems are used, e.g., by transportation systems to identify persons or moving goods, for example. For this purpose, the required data are transmitted by a read/write device over a contactless data transmission link, e.g., an air interface, to a mobile data memory and back again. The contactless identification method also enables the collection of data, e.g., as the mobile data memory moves past. To enable the mobile data memories to be used for an indefinite period of time, the integration of energy storage mechanisms, e.g., batteries, is dispensed with. The necessary electrical energy is picked up externally without contact, i.e., from an electric or magnetic exciter field originating from the read/write device.

To enable communication of a read/write device with such mobile data memories, suitable transmission and coding methods are required, which ensure the power supply of the electronics on the mobile data memory as well as compliance with radio regulations. In addition, only certain frequency bands are typically available for the transmission of data, e.g., the ISM (Industrial, Scientific & Medical) frequency bands for industrial, scientific and medical applications.

Such methods are described, for example, in ISO/IEC Standard 15693, Part 2, “Air Interface and Initialization,” or in ISO/IEC Standard 14443, which deals with time slot methods for operating in an ISM frequency band. Other known methods are, for example, the ISO Standards 11784 and 11785.

If a mobile data memory enters the aforementioned exciter field of a read/write device, it transmits its entire data content cyclically until it leaves the exciter field again. Typically, the data content is taken from an electronic memory, e.g., a non-volatile programmable EEPROM or a FRAM. Due to the binary memory architecture, the aforementioned electronic memories have a binary address space with, for example, 32, 64, 128, etc., addresses. Depending on the organization of the memory, e.g., 1 bit, 4 bits or 8 bits of data can be stored per address. For mobile data memories with serial data transmission, a memory organization of 1 bit per address is usually advantageous. For one data transmission cycle, the binary data contents of all addresses are thus read out and transmitted.

If a user requires a raw data volume or a user data volume of 40 bits, the prior art calls for a mobile data storage device with at least a 64-bit data memory. The 24 memory addresses that are not required are then cyclically read and transmitted as a pre-allocated zero or one sequence. Consequently, a correspondingly configured read/write device also accepts only the, for instance, first 40 bits of the transmitted data.

This, however, presents a problem, in that, for applications requiring a higher crossing speed between the mobile data memory and the read/write device, the aforementioned mobile data memories can no longer be used. This may be the case, for example, in the fields of automation technology and logistics, where production and process steps are continuously optimized and accelerated.

A further problem is encountered when the user data volume must be subsequently increased, e.g., to enable a larger number of mobile data memories in circulation still to be coded individually. For, example, if the required user data volume is 70 bits instead of the aforementioned 40 bits, then a mobile data memory with the next higher, i.e. twice the storage area of 128 bits is required. As a result, almost twice the amount of time is required for cyclic data transmission. This means, in turn, that the crossing speed has to be reduced significantly to ensure reliable data transmission. These mobile data memories may then no longer be usable because the read/write device can no longer read the data content in time within one cycle.

### OBJECTS OF THE INVENTION

Thus, one object of the invention is to provide a novel method as well as a novel mobile data memory, read/write device and identification system, to enable faster data transmission to a read/write device while a mobile data memory moves past the read/write device.

### SUMMARY OF THE INVENTION

According to one formulation of the invention, this and other objects are attained by a method for transmitting data of a mobile data memory to a read/write device, particularly over an air interface, such that the data can be stored in a programmable electronic memory with a fixed memory size and only a predefined amount of user data is transmitted from the electronic memory.

These objects are further attained by a mobile data memory, by a read/write device, and by an identification system in accordance with various further formulations of the invention.. Advantageous embodiments of the method and devices are set forth in dependent claims and described in further detail below.

The invention provides the advantage that only the required amount of data, or the user data sufficient for coding, is transmitted to a read/write device. As a result, the crossing speed and/or the transmittable data volume during crossing can be increased.

A further advantage is that the user can individually adjust the number of user data to be transmitted when programming the user data volume.

### BRIEF DESCRIPTION OF THE DRAWINGS

The invention will now be described in greater detail with reference to the following figures in which:

FIG. 1 shows an example of an identification system, which has a read/write device and a mobile data memory, each with a coding device, for carrying out the method according the invention for the contactless exchange of data,

FIG. 2 shows the configuration of a programmable electronic memory device with a fixed memory size for storing user data according to the invention,

FIG. 3 shows a detail, by way of example, of a data protocol for cyclic data transmission between a mobile data memory and a read/write device according to the invention, and

FIG. 4 shows a program flow, by way of example, for the cyclic readout of a predefined number of user data, which is carried out by a coding device of the mobile data memory according to the invention.

### DETAILED DESCRIPTION OF THE PREFERRED EMBODIMENTS

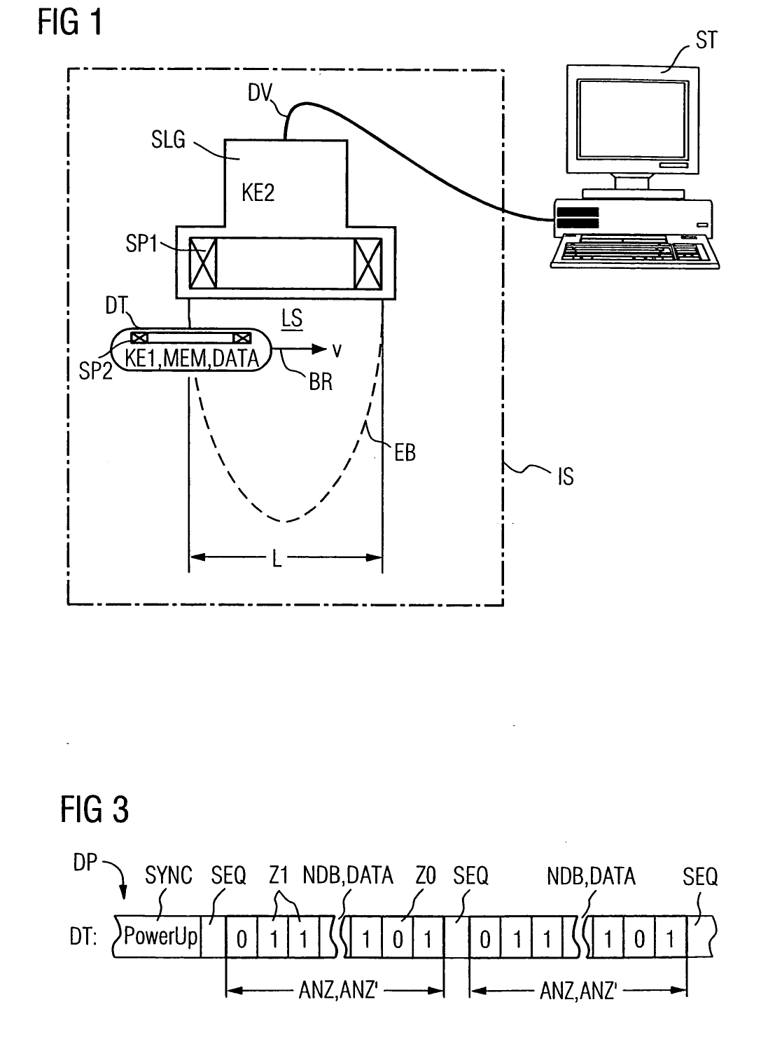

FIG. 1 shows an example of an identification system IS, which has a read/write device SLG and a mobile data memory DT, each respectively provided with a coding device KE1, KE2, for carrying out the method according to the invention. The mobile data memory DT moves at a crossing speed v relative to the read/write device SLG. In the example shown in the figure, the data DATA are transmitted from an electronic memory MEM to the read/write device SLG over a contactless data transmission link LS, e.g., an air interface. In the upper right portion of the figure, a control computer ST is shown by way of example, which is connected to the read/write device SLG via a data connection DV. This data connection is used to exchange data between the control computer ST and the read/write device SLG, e.g., for data collection. In the example depicted in the figure, the dashed line illustrates the collection range EB with a length L of an exciter field generated by the read/write device SLG. Within this collection range EB, data can be transmitted from the mobile data memory DT to the read/write device SLG and vice versa. For purposes of illustration, the corresponding transceiver coils SP1, SP2 are indicated in the example of FIG. 1. At a predefined data rate of the exemplary mobile data memory DT for a crossing speed v, it is possible to transmit a number of data bits equal to the product of the data rate and the length L of the collection range EB, divided by the crossing speed v.

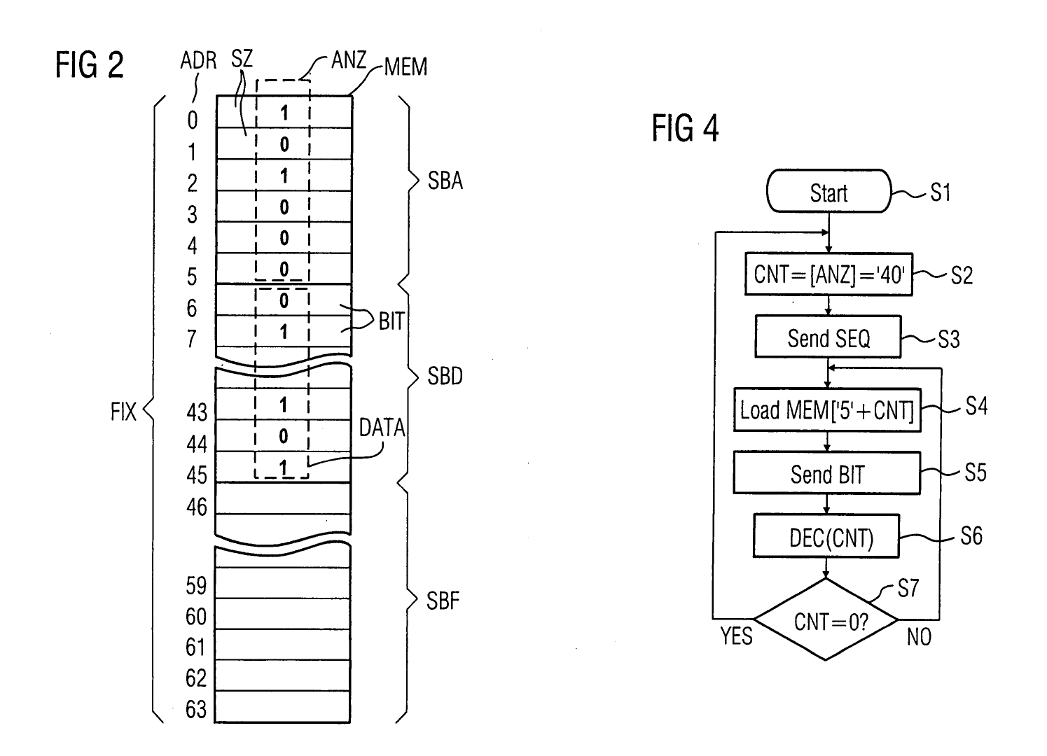

FIG. 2 shows an exemplary structure of a programmable electronic memory MEM with a fixed memory size FIX with 64 addresses ADR for storing user data DATA. One bit can be stored as an information unit in each addressable memory cell SZ. In other words, 64 bits are available to code, for example, a serial number of a product in binary form.

According to the invention, only a predefined amount of data DATA is transmitted from the electronic memory MEM, such that a user can individually program the user data DATA. For this purpose, the amount of user data DATA to be transmitted can be stored as a coded value ANZ in the mobile data memory DT, particularly in a predefined memory area SBA of the electronic memory MEM.

In the example of FIG. 2, the memory area SBA with the address range ADR 0 to 5 is reserved for storing the coded value ANZ of the amount of user data DATA to be transmitted. The 6 bits available are sufficient to code the value ANZ of the user data DATA to be transmitted within a range from 0 to 63. The actual user data DATA start in the address ADR 6 following the memory area SBA. This leaves 64 bits minus 6 bits equals 58 bits of possible user data DATA, which can be stored in the electronic memory MEM. According to the invention, the actual user data volume DATA is cyclically read from the memory MEM and then transmitted. In the example of this figure, a user data volume DATA of only 40 bits is required. The coded value ANZ of the number ‘40’ is stored as a binary sequence ‘101000’ in the memory area SBA. In the following memory area SBD, only some of the individual bits BIT of the user data DATA are shown. This leaves a free memory area SBF, which is not required or used.

This has the particular advantage that only the required amount of user data DATA and their exact number ANZ are defined in the electronic memory MEM. Thus, for data transmission, only these data need to be read and transmitted.

A further advantage is that it is possible to use only one electronic memory MEM for storing both the user data DATA and the coded value ANZ of the number of user data DATA to be transmitted.

FIG. 3 shows a corresponding detail of an exemplary data protocol DP for cyclic data transmission between a mobile data memory DT and a read/write device SLG corresponding to the memory structure depicted in FIG. 2. As the mobile data memory DT enters the exciter field, the mobile data memory DT is powered up (Power UP) and synchronized with the read/write device SLG in the first time block SYNC.

According to the invention, the user data DATA “marked” in the electronic memory MEM are cyclically transmitted in a user data time block NDB, such that the respective user data time blocks NDB consist of a sequence of on and off values (1, 0). The on and off values (1, 0) can also be considered time slots (Z1, Z0), which for data transmission can be modulated (Z1) or unmodulated (Z0) corresponding to the respective on and off values (1, 0).

Furthermore, according to the invention, the data bits BIT of the user data DATA to be transmitted can be recoded. This is the case if, for example, a transmission method without a sub-carrier is used according to the ISO/IEC standard 14443. To ensure that the mobile data memory DT receives an adequate amount of power from the read/write device SLG during data transmission, at least one unmodulated time slot Z0 must follow a modulated time slot Z1. In this case, the number ANZ′ of the time slots Z0, Z1 to be transmitted, representing the data bits BIT, may increase.

Furthermore, the corresponding user data DATA, or the user data blocks NDB representing them, can be cyclically separated from a significant start/stop identifier SEQ. For delimitation against the data bits BIT to be transmitted, or the corresponding time slots Z1, Z0, this identifier can have, e.g., a different modulation or a significant bit sequence.

This has the advantage that a suitable read/write device SLG with a second coding device KE2 according to the invention can separate a valid user data block NDB or a valid number of user data DATA between two start/stop identifiers SEQ.

FIG. 4, by way of example, shows a program sequence S1-S7 for the cyclic readout of a predefined number ANZ of user data DATA, which is executed by a first coding device KE1 of the mobile data memory DT according to the invention.

To transmit data to a read/write device SLG, the mobile data memory DT according to the invention has at least one user-programmable electronic memory MEM with a fixed memory size FIX for storing data, such that at least a predefined amount of user data DATA can be stored in the memory MEM. In addition, the mobile data memory DT has a first coding device KE1, at least for transmitting data from the electronic memory MEM. The mobile data memory DT further has storage means for storing the coded value ANZ of the predefined number of user data DATA. In particular, the electronic memory MEM is used for storing the coded value ANZ of the amount of user data DATA. According to the invention, only the amount of user data DATA in the electronic memory MEM addressed by the coded value ANZ is transmitted, preferably cyclically, by the first coding device KE1 to the read/write device SLG.

The program flow, illustrated by way of example, starts with program step S1, e.g., after a power-up reset when the mobile data memory DT enters the exciter field.

In the following step S2 an internal counter CNT is loaded, e.g., with the value ANZ ‘40’ of the user data volume DATA from the electronic memory MEM. In program step S3 the mobile data memory DT sends a start/stop identifier SEQ to the read/write device SLG. Thereafter, in program step S4, the memory area SBD addressed with the user data DATA is read out as a bit sequence. In the example of the figure, this is done in reverse order starting with the address 45 up to address 6. For this purpose, each BIT that is read out is sent in program step S5 and the counter CNT is subsequently lowered. The steps S4-S7 are cyclically repeated until the counter CNT has the value 0 in program step S7, after which the program goes to step S2 for a new transmission cycle.

The program sequence S1-S7 can advantageously be implemented simply by circuit and/or program means, e.g., in the coding device KE1 of a mobile data memory DT.

Finally, to carry out the method according to the invention, an identification system IS can be operated in an ISM frequency band. The identification system IS can include at least one read/write device SLG and at least one mobile data memory DT, which transmit data over a contactless data transmission link LS, particularly over an air interface LS, by way of inductive coupling.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

1. A method for transmitting data of a mobile data memory to a read-write device, comprising:
storing the data in a programmable electronic memory with a fixed memory size,
transmitting only a predefined amount of user data from the electronic memory.

2. The method as claimed in claim 1, wherein the data are transmitted over an air interface.

3. The method as claimed in claim 1, wherein the user data are programmed by a user.

4. The method as claimed in claim 1, wherein a value designating the amount of the user data to be transmitted is stored in the mobile data memory as a coded value.

5. The method as claimed in claim 4, wherein the coded value is stored in a predefined memory area of the electronic memory.

6. The method as claimed in claim 1, wherein the amount of the user data is transmitted cyclically.

7. The method as claimed in claim 6, wherein the amount of the user data transmitted cyclically follows a start-stop identifier for the read-write device.

8. The method as claimed in claim 1, wherein the amount of the user data to be transmitted is represented by a sequence of on and off values in a time-slot grid.

9. The method as claimed in claim 1, further comprising:
receiving and evaluating the amount of the user data in the read-write device.

10. The method as claimed in claim 1, wherein the transmitting is performed in an ISM frequency band.

11. A mobile data memory for transmitting data to a read-write device, comprising:
a user-programmable electronic memory having a fixed memory size for storing data, wherein at least a predefined amount of user data is stored in the memory, and
a first coding device at least for transmitting data from the electronic memory, and
storage means for storing a coded value of the predefined amount of the user data,
wherein the first coding device is configured to transmit, to the read-write device, the amount of user data in the electronic memory that is addressed by the coded value.

12. The mobile data memory as claimed in claim 11, wherein the electronic memory includes the storage means for storing the coded value of the amount of the user data.

13. The mobile data memory as claimed in claim 11, wherein the amount of the user data is cyclically transmitted to the read-write device by the first coding device.

14. The mobile data memory as claimed in claim 11, wherein the amount of the user data to be transmitted is transmitted to the read-write device by the first coding device as a sequence of on and off values in a time-slot grid, wherein the amount of the user data is represented by the sequence.

15. The mobile data memory as claimed in claim 11, wherein the mobile data memory is a read-only data memory.

16. An identification system, comprising:
a read-write device; and
at least one mobile data memory comprising:
a user-programmable electronic memory having a fixed memory size for storing data, wherein at least a predefined amount of user data is stored in the memory, and
a first coding device at least for transmitting data from the electronic memory, and
storage means for storing a coded value of the predefined amount of the user data,
wherein the first coding device is configured to transmit, to the read-write device, the amount of user data in the electronic memory that is addressed by the coded value.

17. The identification system as claimed in claim 16, wherein the read-write device comprises a second coding device for receiving and evaluating the amount of the user data.

18. The identification system as claimed in claim 16, wherein the read-write device and the mobile data memory are configured to transmit data over a contactless data transmission link by way of inductive coupling.

19. The identification system as claimed in claim 18, wherein the transmission link is an air interface.

20. A method, comprising:
storing an amount of data together with a value designating the amount of the data stored in a mobile data memory, wherein the mobile data memory is configured to store data in a quantity exceeding the amount of data stored; and
transmitting the data stored together with the value designating the amount of the data stored from the mobile data memory, without transmitting dummy data corresponding to the quantity exceeding the amount of data stored.

21. The method according to claim 20, further comprising:
receiving and evaluating the value and the data transmitted in a stationary read-write device.
